(19) United States
(12) Patent Application Publication
(10) Pub. No.: US 2004/0128839 A1
(43) Pub. Date: Jul. 8, 2004

(54) Snap-on and slidable assist handle for filament trimmer

(76) Inventors: Chadwick A. Shaffer, Oakdale, MN (US); John O. Hurst, Savage, MN (US)

Correspondence Address: James W. Miller, Esq., Attorney at Law, Foshay Tower, Suite 1005, 821 Marquette Avenue, Minneapolis, MN, 55402, US

(21) Appl. No.: 10/337,218

(22) Filed: Jan. 6, 2003

(51) Int. Cl. B26B 7/00; B26B 27/00

(52) U.S. Cl. 30/276; 30/296.1

(57) ABSTRACT

A filament trimmer comprises a lower housing, an upper handle, and a connecting tube extending between and uniting the lower housing and upper handle. An assist handle is located on the connecting tube to allow an operator to grip and hold the filament trimmer with two hands, namely with one hand on the upper handle and the other hand on the assist handle. The assist handle includes a hub that snaps onto the connecting tube to allow the assist handle to be installed on the connecting tube without using fasteners. The hub has flexible sides that allow the hub to be snapped over the connecting tube with the hub and the connecting tube having mating non-circular cross-sections. The holding force provided by the hub keeps the hub stationary on the connecting tube during normal operation of the trimmer. However, the operator can reposition the assist handle along the connecting tube by applying a greater force than the holding force to slide the assist handle up or down the connecting tube.

### TECHNICAL FIELD

This invention relates to a filament trimmer having a flexible filament that severs grass or other ground growing vegetation when the filament is spun in a cutting plane. More particularly, this invention relates to a handheld filament trimmer having an assist handle as well as an upper handle to allow the operator to grip and hold the filament trimmer with both hands.

### BACKGROUND OF THE INVENTION

Filament trimmers are well known lawn and garden implements for trimming grass or the like. Such trimmers are handheld implements comprising a lower housing, an upper handle, and an intermediate connecting tube joining the lower housing and upper handle. A trimmer head is rotatably carried on the lower housing. The trimmer head includes a flexible filament extending outwardly therefrom with the filament serving as a cutting element when the filament is swung or rotated in a cutting plane by rotation of the trimmer head.

The operator desirably holds the trimmer with both hands. The operator uses one hand to grip the upper handle. The operator grips an additional assist handle with the operator's other hand. The assist handle is often located on the connecting tube. Using both hands to grip the upper handle and the assist handle helps the operator balance out the forces involved and eases the task of holding the trimmer.

Many filament trimmers are shipped disassembled in a box and must be assembled by the purchaser prior to use. One thing that must be done is to install the assist handle on the intermediate connecting tube. Many assist handles have a split clamping bracket that can be slipped around the connecting tube. A threaded connector, such as a bolt, must be installed and tightened to non-rotatably secure the clamping bracket to the connecting tube. Once the connector is properly tightened, the assist handle is fixed in position on the connecting tube.

One difficulty with the prior method for attaching the assist handle to the connecting tube is the need for a threaded connector to tighten or clamp the clamping bracket to the connecting tube. For one thing, the connector must be provided by the manufacturer as part of the filament trimmer, thus requiring the manufacturer to purchase such a connector and to include the connector with the trimmer. If the connector is lost or misplaced by the purchaser, the assist handle cannot be installed without replacing the connector. Moreover, it takes some time and effort on the part of the purchaser to properly install and tighten the connector.

Moreover, a filament trimmer may be used by different people in the same household. The location of the assist handle along the connecting tube is a matter of individual preference dictated in part by the height of the operator. One operator might prefer that the assist handle be located higher up on the connecting tube than a location that would be desired by a different operator. Thus, if different operators use the filament trimmer, it is often necessary to adjust the position of the assist handle along the connecting tube.

However, with known assist handles, the location of the assist handle along the connecting tube can be somewhat cumbersome to adjust. It requires that the threaded connector used to tighten or clamp the assist handle to the connecting tube be loosened, that the assist handle be slid along the connecting tube to a new and desired location, and that the threaded connector then be retightened. The loosening and tightening of the threaded connector may require a tool which must either be on hand or easily available. Even if no tool is required when the threaded connector carries a knob or wingnut which remains on the connector, it may be difficult to loosen and retighten the connector by hand. This is especially so if the connector has been exposed to weather and has become corroded in any way. As a consequence, many operators might choose not to reposition the assist handle, even though its current location along the connecting tube is not ideally suited to them.

### SUMMARY OF THE INVENTION

One aspect of this invention relates to a filament trimmer which comprises a housing. The housing comprises a lower housing, an upper handle, and a connecting tube joining the lower housing and upper handle together. A trimmer head is rotatably carried on the lower housing and has a flexible filament extending radially outwardly therefrom. A drive is carried on the housing for rotating the trimmer head to rotate the flexible filament in a cutting plane to sever ground growing vegetation. An assist handle is carried on the connecting tube to allow an operator to grip and position the housing of the trimmer in a two handed manner with one hand of the operator gripping the upper handle and the other hand of the operator gripping the assist handle. The assist handle is configured to have a snap fit to the connecting tube to permit the assist handle to snap onto the connecting tube to thereby allow the assist handle to be installed and removed from the connecting tube without using fasteners.

Another aspect of this invention relates to a filament trimmer for trimming ground growing vegetation. The trimmer comprises a lower housing, an upper handle, and a connecting tube extending between and uniting the lower housing and upper handle. An assist handle is located on the connecting tube to allow an operator to grip and hold the filament trimmer with two hands with one hand on the upper handle and the other hand on the assist handle. The assist handle includes a hub with flexible sides that permit the hub to snap onto the connecting tube to allow the assist handle to be installed on the connecting tube without using fasteners. The flexible sides of the hub grip the connecting tube with a holding force that keeps the hub stationary on the connecting tube during normal operation of the trimmer.

### BRIEF DESCRIPTION OF THE DRAWINGS

This invention will be described more completely in the following Detailed Description, when taken in conjunction with the following drawings, in which like reference numerals refer to like elements throughout.

FIG. 1 is a perspective view of a filament trimmer according to this invention, particularly illustrating a trimmer with a first embodiment of a snap-on assist handle carried on the connecting tube that joins the upper handle to the lower housing of the filament trimmer;

FIG. 2 is an enlarged perspective view of a portion of the filament trimmer shown in FIG. 1, particularly illustrating the assist handle snapped onto the connecting tube;

FIG. 3 is a cross-sectional view of the filament trimmer shown in FIG. 1 taken along lines 3-3 in FIG. 2, particularly illustrating the assist handle snapped onto the connecting tube;

FIG. 4 is a cross-sectional view similar to FIG. 3, but comprising an exploded view illustrating the assist handle separated from the connecting tube; and

FIG. 5 is a cross-sectional view similar to FIG. 4, particularly illustrating a second embodiment of an assist handle that can be used on the filament trimmer of FIG. 1.

### DETAILED DESCRIPTION

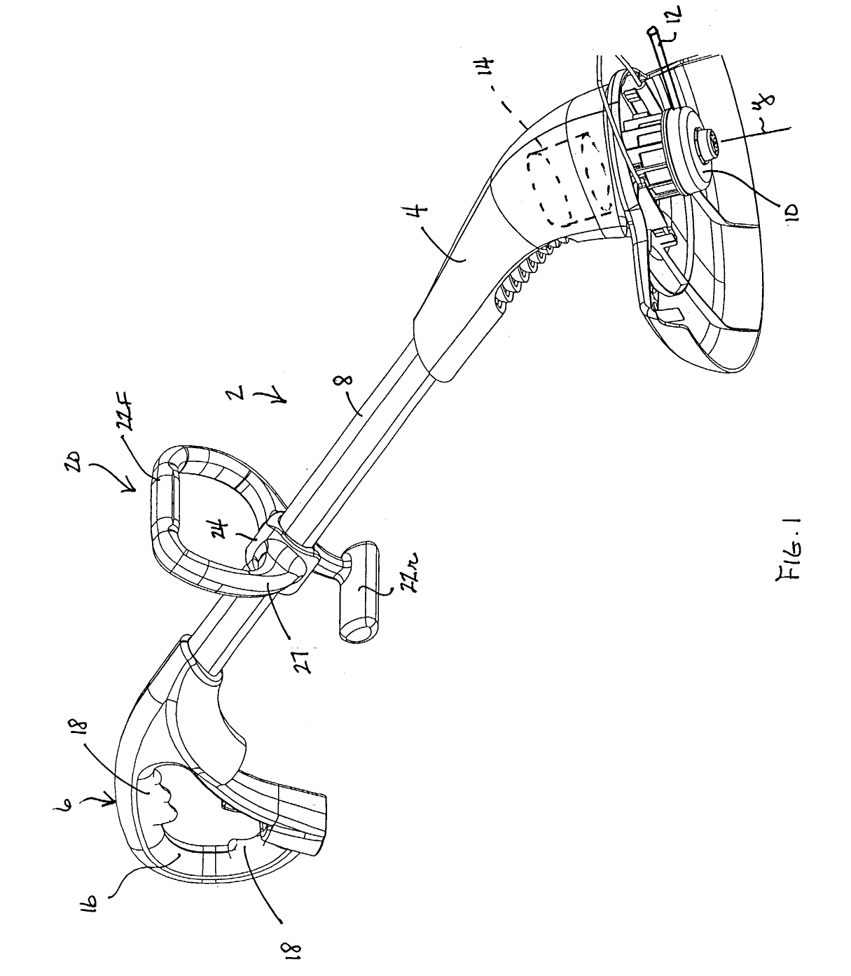

FIG. 1 illustrates a filament trimmer 2 according to this invention. Filament trimmer 2 includes a lower housing 4, an upper handle 6, and an elongated connecting tube 8 joining lower housing 4 and upper handle 6 together. A rotatable trimmer head 10 is carried on lower housing 4. Trimmer head 10 includes a radially outwardly extending flexible filament 12. When trimmer head 10 is rotated relative to lower housing 4 around an axis y, filament 12 is able to cut or trim grass or other ground growing vegetation.

Filament trimmer 2 includes a powered drive 14 for rotating trimmer head 10. One type of drive 14 that may be used comprises an electric motor carried in lower housing 4 and operatively coupled to trimmer head 10 for rotating trimmer head 10 when the electric motor is energized from some electrical power source. The electrical power source (not shown) can comprise a battery carried on upper handle 6 of filament trimmer 2 or a power supply cord plugged into the back of upper handle 6 of filament trimmer 2. Alternatively, drive 14 for rotating trimmer head 10 could also comprise a small internal combustion engine carried on the upper end of filament trimmer 2 having an elongated flexible drive shaft extending down through connecting tube 8 and lower housing 4 and coupled to trimmer head 10 for rotating trimmer head 10 when the internal combustion engine is running. The type of drive 14 used in conjunction with trimmer head 10 is not important to this invention.

Upper handle 6 includes a hand grip 16 and one or more triggers 18 for initiating operation of drive 14. The operator can grip upper handle 6 with one hand with the operator's fingers being curled around hand grip 16. The operator can selectively start and stop rotation of trimmer head 10 by squeezing a trigger 18 closed.

It would be difficult for most operators to hold filament trimmer 2 for an extended period of time using just one hand gripping upper handle 6. Accordingly, many known filament trimmers also include an assist handle 20 on connecting tube 8. Assist handle 20 provides at least one additional hand grip 22 to allow the operator to grip assist handle 20 with the operator's other hand, i.e. with the hand that is not used to grip upper handle 6. Thus, the combination of upper handle 6 and assist handle 20 allow the operator to grip and hold filament trimmer 2 with both hands in a balanced manner, thereby permitting the operator to operate filament trimmer 2 for extended periods of time without becoming unduly tired.

FIGS. 1-4 illustrate a first embodiment of an assist handle 20. Assist handle 20 includes a relatively short hub 24 having a bore 26 passing therethrough to allow connecting tube 8 to be received within bore 26. Bore 26 is enclosed around its periphery except that one side of bore 26 is open to allow assist handle 20 to be snapped onto connecting tube 8. This snap fit will be described in more detail hereafter.

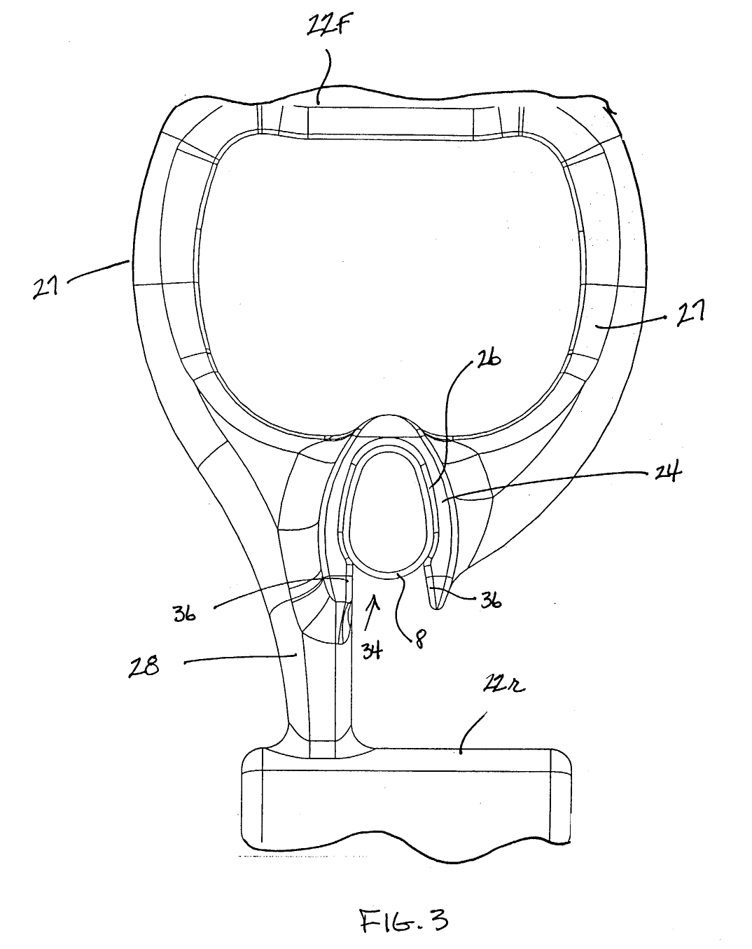

Assist handle 20 shown in FIGS. 1-4 includes a front hand grip 22_{f} formed by a loop type grip, the sides 27 of the loop being joined to the sides of hub 24. Assist handle 20 further includes a rear hand grip 22ᵣ formed by an L-shaped grip, one leg 28 of the L-shaped grip 22ᵣ being joined to one side of hub 24. In fact, the leg 28 of the L-shaped rear hand grip 22ᵣ which connects to hub 24 is actually a continuation or extension of one side 27 of the loop shaped grip that forms front hand grip 22_{f}. See FIG. 3. However, the L-shaped rear hand grip 22ᵣ could be entirely separate from the loop shaped front hand grip 22_{f} with both hand grips 22_{f} and 22ᵣ joining to hub 24 at different locations if so desired.

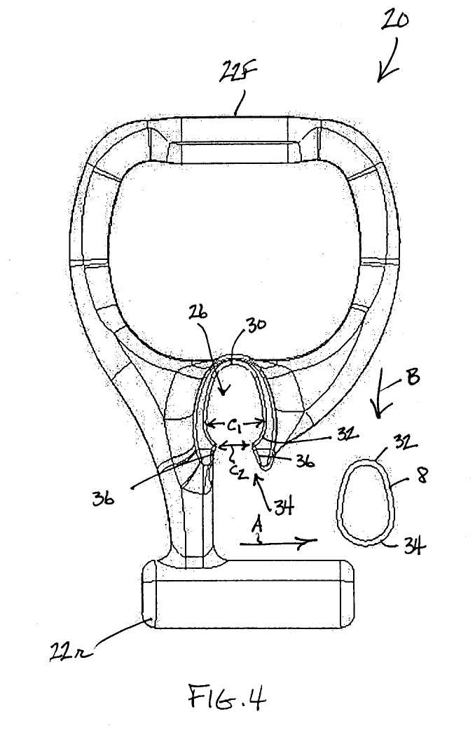

Referring now to FIG. 4, bore 26 through hub 24 of assist handle 20 includes an ovate cross-section that includes a rounded narrower end 30 and a rounded broader end 32. The open side of bore 26 is at broader end 32 of the ovate cross-section. In addition, bore 26 includes a tapered entrance 34 to the ovate cross-section. The tapered entrance 34 is formed between two transversely spaced side surfaces 36 that converge as one proceeds inwardly towards the ovate cross-section. See FIG. 3.

Referring further to FIG. 4, the ovate cross-section has a chord of maximum length which is located where the ovate cross-section is widest. This maximum length chord is indicated as c₁ in FIG. 4. Side surfaces 36 forming tapered entrance 34 join to the ovate cross-section along a chord, indicated as c₂, which is shorter than the maximum length chord c₁ and which is nearer the tip of broader end 32 of the ovate cross-section than is the maximum length chord c₁. In fact, all portions of the ovate cross-section lying below the chord c₂ at which tapered entrance 34 joins the ovate cross-section are removed, thus providing the one open side which bore 26 must have to allow hub 24 to be snapped onto connecting tube 8.

Referring yet again to FIG. 4, connecting tube 8 has a similar mating ovate cross-section to the ovate cross-section of bore 26. Bore 26 of assist handle 20 snaps onto connecting tube 8. As shown in FIG. 4, assist handle 20 is first positioned to one side of connecting tube 8 so that assist handle 20 can be moved laterally as indicated by the arrow A to move assist handle 20 over connecting tube 8 with connecting tube 8 then being received between hub 24 and the rear hand grip. Then, assist handle 20 can be pushed downwardly as indicated by the arrow B in FIG. 4 to snap bore 26 of assist handle 20 down over connecting tube 8. When assist handle 20 is so joined to connecting tube 8, the ovate cross-sections of bore 26 and connecting tube 8 will nest or mate together as depicted in FIGS. 1-3.

As bore 26 of assist handle 20 snaps down over connecting tube 8, the open side of bore 26 along the chord c₂ will at some point engage against the sides of connecting tube 8 before the maximum length chord c₁ of the ovate cross-section of connecting tube 8 is reached. As the operator continues to push assist handle 20 down onto connecting tube 8, the increasing width of the ovate cross-section of connecting tube 8 will cam or push outwardly against the chord c₂ of the ovate cross-section on assist handle 20 to effectively spread bore 26 apart just enough to allow bore 26 to pass over connecting tube 8. There is enough flexibility between the sides of hub 24 to allow this spreading to occur. Once assist handle 20 is fully snapped onto the handle and the ovate cross-sections are nested together, the sides of bore 26 will-snap back and around connecting tube 8 to firmly hold assist handle 20 on connecting tube 8.

Assist handle 20 and particularly hub 24 thereof is molded in one-piece from plastic. The amount of flexibility provided in the sides of hub 24 is chosen to be sufficient to allow hub 24 to be snapped over connecting tube 8 to install assist handle 20 to connecting tube 8 without using any fasteners. In addition, the holding force provided by hub 24 is sufficient to allow hub 24 to grip connecting tube 8 and to stay in place during normal operation of filament trimmer 2. In other words, as the operator operates trimmer 2 and holds assist handle 20 with one hand with the other hand gripping upper handle 6, assist handle 20 will not slide along connecting tube 8 but will remain stationary.

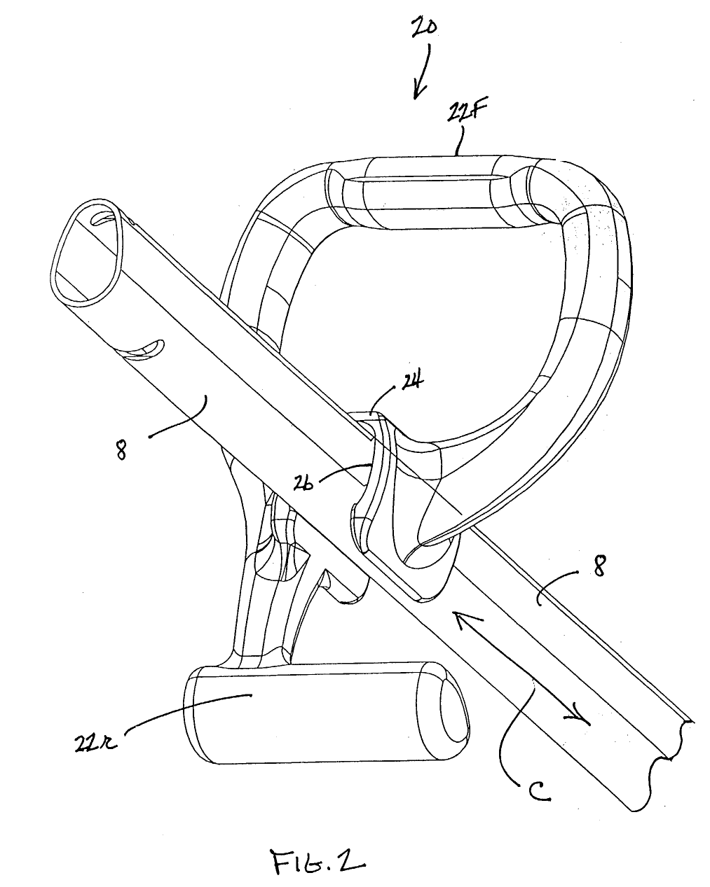

However, the flexibility of hub 24 and the holding force provided thereby is also chosen to permit assist handle 20 to be selectively slid up and down along connecting tube 8 to reposition assist handle 20 if such repositioning is desired. In other words, the operator can push or pull on assist handle 20, using a force indicated by the arrows C in FIG. 2, if the operator so desires. When a force sufficiently large is supplied by the operator in the direction of the arrows C, assist handle 20 will slide up or down along connecting tube 8 depending upon whether an upward or downward force was applied.

Filament trimmer 2 of this invention has various advantages over prior art filament trimmers. Assist handle 20 can be installed and removed from connecting tube 8 without having to find and use threaded fasteners merely by snapping assist handle 20 onto or pulling assist handle 20 off of connecting tube 8. This can be done quickly and without needing any tools. Moreover, once in place, assist handle 20 will stay in place on connecting tube 8 during normal operation of the trimmer and will not rotate around connecting tube 8 due to the mating non-circular cross-sections used for both bore 26 of hub 24 of assist handle 20 and for connecting tube 8.

Moreover, assist handle 20 can be quickly and easily repositioned along the length of connecting tube 8 merely by applying a force in the direction of one of the arrows C which is large enough to overcome the holding force provided by hub 24 and to slide assist handle 20 up or down. Again, this allows repositioning of assist handle 20 without having to loosen or tighten any fasteners. The ease of repositioning assist handle 20 will encourage different operators to locate assist handle 20 where they find it to be most comfortable and useful. This will increase the ease of using filament trimmer 2.

While repositioning assist handle 20 merely by sliding it up and down connecting tube 8 is preferred, the snap-on and snap-off aspects of assist handle 20 are not tied to this. The holding force provided by hub 24 could be strong enough to prevent the operator from sliding assist handle 20 up and down along connecting tube 8. In this event, assist handle 20 would be repositioned or relocated along connecting tube 8 by snapping assist handle 20 off connecting tube 8, by repositioning assist handle 20 at a different location on connecting tube 8, and by then snapping assist handle 20 back onto connecting tube 8 at the new location.

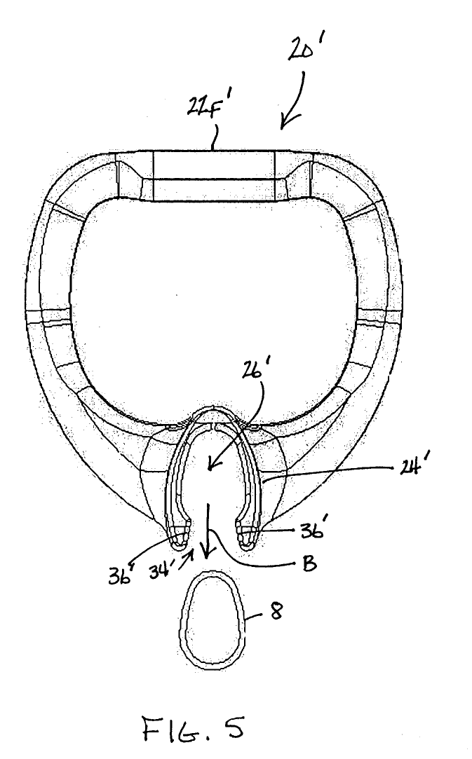

FIG. 5 illustrates an alternative embodiment of an assist handle 20′ that can be used on a filament trimmer 2 according to this invention. Assist handle 20′ shown in FIG. 5 is the same as in FIG. 4 except that the rear L-shaped hand grip 22ᵣ has been deleted from assist handle 20′, leaving only front hand grip 22_{f}′. Assist handle 20′ as shown in FIG. 5 is installed or snapped onto connecting tube 8 simply by aligning bore 26′ in hub 24′ of assist handle 20′ with connecting tube 8 and by pushing down on assist handle 20′ in the direction of arrow B. There is no need to first laterally move assist handle 20′ in the direction of arrow A, as was true for assist handle 20 shown in FIGS. 1-4.

Assist handle 20 shown in FIGS. 1-4 would be used on a filament trimmer 2 that could be flipped over and used in either a trim mode or an edge mode. Assist handle 20′ shown in FIG. 5 would be used on a filament trimmer 2 that would be used in only one position to provide just a trim mode.

Various modifications of this invention will be apparent to those skilled in the art. Thus, the scope of the invention shall be limited only by the appended claims.

We claim:

1. A filament trimmer, which comprises:
(a) a housing which comprises:
(i) a lower housing,
(ii) an upper handle, and
(iii) a connecting tube joining the lower housing and upper handle together;
(b) a trimmer head rotatably carried on the lower housing and having a flexible filament extending radially outwardly therefrom;
(c) a drive carried on the housing for rotating the trimmer head to rotate the flexible filament in a cutting plane to sever ground growing vegetation;
(d) an assist handle carried on the connecting tube to allow an operator to grip and position the housing of the trimmer in a two handed manner with one hand of the operator gripping the upper handle and the other hand of the operator gripping the assist handle; and
(e) wherein the assist handle is configured to have a snap fit to the connecting tube to permit the assist handle to snap onto the connecting tube to thereby allow the assist handle to be installed and removed from the connecting tube without using fasteners.

2. The filament trimmer of claim 1, wherein the assist handle includes a hub having a bore that is open along one side to allow the open side of the bore to be abutted against the connecting tube with the hub being snapped onto the connecting tube by pushing on the assist handle in a direction which moves the open side of the bore over the connecting tube until the bore has moved onto the connecting tube with the connecting tube seated in the bore.

3. The filament trimmer of claim 2, wherein the bore and the connecting tube have mating non-circular cross-sectional configurations.

4. The filament trimmer of claim 3, wherein the bore and the connecting tube have mating ovate cross-sectional configurations with a rounded broader end and a rounded narrower end.

5. The filament trimmer of claim 4, wherein the open side of the bore is at the rounded broader end of the ovate cross-sectional configuration of the bore.

6. The filament trimmer of claim 5, wherein the hub includes an entrance to the open side of the bore which entrance has transversely spaced and opposed straight side surfaces that converge relative to one another as one proceeds inwardly through the entrance towards the bore.

7. The filament trimmer of claim 6, wherein the broader end of the bore includes a chord of maximum length at a widest portion of the broader end of the bore, and wherein the side surfaces of the entrance join the broader end of the bore along a chord having a shorter length than the maximum length chord and that is reached before the maximum length chord is reached.

8. The filament trimmer of claim 2, wherein the hub is configured to grip the connecting tube with a holding force sufficient to keep the assist handle stationary on the connecting force when the filament trimmer is operated and is held by the operator using the upper handle and the assist handle.

9. The filament trimmer of claim 8, wherein the holding force can be overcome by the operator by selectively applying a force larger than the holding force in a direction which causes the hub to slide up or down the connecting tube, wherein the assist handle can be repositioned on the connecting tube without having to remove the assist handle from the connecting tube.

10. The filament trimmer of claim 2, wherein the assist handle includes at least a first hand grip secured to the hub.

11. The filament trimmer of claim 10, wherein the hand grip and the hub are integrally molded together as one piece from plastic.

12. The filament trimmer of claim 10, wherein the assist handle further includes a second hand grip secured to the hub, wherein the first hand grip is positioned in front of the connecting tube and the second hand grip is positioned behind the connecting tube when the assist handle is snapped onto the connecting tube.

13. The filament trimmer of claim 1, wherein the drive for rotating the trimmer head comprises an electric motor carried in the housing.

14. The filament trimmer of claim 1, wherein the drive is carried in the lower housing.

15. A filament trimmer for trimming ground growing vegetation, which comprises
(a) a lower housing, an upper handle, and a connecting tube extending between and uniting the lower housing and upper handle;
(b) an assist handle located on the connecting tube to allow an operator to grip and hold the filament trimmer with two hands with one hand on the upper handle and the other hand on the assist handle; and
(c) wherein the assist handle includes a hub with sides that are flexible relative to one another to permit the hub to snap onto the connecting tube to allow the assist handle to be installed on the connecting tube without using fasteners, and wherein the flexible sides of the hub grip the connecting tube with a holding force that keeps the hub stationary on the connecting tube during normal operation of the trimmer.

16. The filament trimmer of claim 15, wherein the hub and connecting tube have mating non-circular cross-sections when the assist handle is snapped onto the connecting tube

17. The filament trimmer of claim 15, wherein the flexible sides of the hub are configured to permit an operator to reposition the assist handle along the connecting tube without removing the assist handle from the connecting tube.
